(19) United States
(12) Patent Application Publication
(10) Pub. No.: US 2008/0219744 A1
(43) Pub. Date: Sep. 11, 2008

(54) Thermal Printing Device

(75) Inventors: Antonio Valverde, Barcelona (ES); Emilio Casado, Terrassa (ES)

Correspondence Address: PEARNE & GORDON LLP, 1801 EAST 9TH STREET, SUITE 1200, CLEVELAND, OH, 44114-3108, US

(73) Assignee: IMAJE TECHNOLOGIAS DE CODIFICACION, Barcelona (ES)

(21) Appl. No.: 12/089,109

(22) PCT Filed: Oct. 13, 2006
(86) PCT No.: PCT/EP2006/067385

§ 371 Date: Apr. 3, 2008

(30) Foreign Application Priority Data
Oct. 17, 2005 (FR) 05 53143

(51) Int. Cl. B41J 33/00

(52) U.S. Cl. 400/234

(57) ABSTRACT

Improvements in a thermal printing ribbon (3) feed cassette (1) make it possible to increase the unwinding speed of the ribbon (3), accelerate the printing frequency, while guaranteeing the printing reliability. A magnetically actuated compensator system (30) is preferably coupled with a braking system on the driven axis (12); in addition, the motor is coupled with a traction roller (18) which drives the winding cylinder (14), each of these two components being preferably equipped with a locking system.

The improvements may be made to existing cassettes.

### TECHNICAL FIELD

The invention relates to devices used to unwind a tape between two reels in a controlled manner, particularly with respect to tension of the tape and optimisation of its feed. More specifically, the invention finds an application for thermal printing with a ribbon running in front of a head used to transfer ink from a ribbon onto a printing substrate.

In particular, the invention relates to mechanical modifications of the support and guiding system of an ink ribbon to accelerate its speed while guaranteeing the print quality and reliability relative to the ribbon tension and the lack of rupture thereof. In addition, using the device according to the invention, it is possible to increase the printing throughput.

The device according to the invention can be applied to existing and/or already running single feed motor printers, without excessive additional costs.

### BACKGROUND ART

The marking of industrial products is increasingly widespread, for instructions for use, expiry dates or traceability-related information such as batch or serial numbers. In this respect, thermal printing is a method of choice: a thermofusible ink ribbon is run from a feed reel to a receiving reel along a feed path whereon a printing head acts in order to transfer ink patterns thermally from the ribbon onto a substrate located adjacent to the feed path. The printing head is mobile with respect to the ribbon feed path, in a rotating or linear fashion, in order to come closer to the ribbon and contact it so as to activate the ink transfer, and to move the ribbon away when printing is complete: see document EP 0 683 055 (Prestek).

The printing head comprises individually activatable tiny heating elements; during printing, the printing head transfers a localised and determined quantity of thermal energy on each element, in order to modify the local properties of the ink in the ribbon and enable the transfer of a controlled quantity of ink from the ribbon to the substrate. To ensure the reliability and reproducibility in the ink transfer phase, the ribbon is driven by a speed substantially equal to that of the printed substrate. Depending on whether the printing substrate is immobile or moving slowly or quickly at the time of printing, several printing options are envisaged for the system.

According to a so-called “intermittent printing” option, the substrate is stationary during printing, the head is put near to the ribbon to come into contact and apply a pressure on the substrate, and then fed by sliding along the ribbon while maintaining the desired pressure over a length dependent on the pattern to be printed while the different heating elements are activated selectively. The head is then deactivated and moved away from the ribbon while both the substrate and the ribbon are fed for a new pattern. The speed and precision with which the printer unwinds the ribbon and repositions it as immobile and taut to start the new printing cycle determine the maximum printing throughput. This method which is one of the simplest to use can only be used for printing with an effective speed of up to 3 m/min.

According to another option known as “continuous printing”, the substrate runs continuously under the printer: to print a pattern, the printing head is moved close to the ribbon until they come into contact while the ribbon is driven by a translation movement, wherein the speed is substantially equal to that of the continuous feed of the substrate: see document U.S. Pat. No. 6,354,753 (Easyprint). The heating elements are activated in contact with the ribbon while said ribbon slides under the printing head and transfers the ink to the running substrate. The printing head is then deactivated and moved away from the ribbon if required while said ribbon is repositioned for the printing of the next pattern. This system is faster but requires a more sophisticated control and synchronisation mechanism between the relative movements of the printing head, ribbon and substrate.

In several alternative embodiments of printing on moving substrates, the printing head may also be driven by a translation movement in the direction of the movement of the substrate during the printing phase, in order to optimise the ink heating performance. In a first embodiment, the printing head may be moved in the same direction as the substrate, when said substrate moves at a high speed, in order to reduce the relative head/ribbon speed and enable an extended heating time; in some cases, the ribbon speed may be kept slightly lower than that of the substrate in order to enable very high-speed printing in any case, to the detriment of its quality. In a second alternative embodiment, when the substrate has a very low speed that is difficult to measure accurately by an external sensor, the printing head may be moved in the opposite direction to the movement of the substrate, with a higher relative speed, which is therefore more controlled for printing.

In any case, the control of the quantity of thermal energy supplied to the ribbon and the control of the pressure applied determine the print quality, so that the best conditions are those in which the relative speed between the printing head and the ribbon is constant. Printing during the ribbon acceleration and deceleration phases generally deteriorates the printed quality.

One consequence is that the maximum effective printing frequency that can be attained is limited by the durations of the ribbon acceleration and deceleration phases.

Another consequence is that significant ribbon losses are caused by the interval corresponding to the ribbon acceleration and deceleration phases between two patterns. These losses are particularly significant in relative values if the printed areas are small in size and the printing is high-frequency.

In order to minimise the ribbon losses, one solution is to “rewind” the ribbon and apply a bidirectional movement thereto between successive printing operations. According to one option, a bidirectional motor is coupled with both feed and winding reels, or two unidirectional motors are used and synchronised: see document U.S. Pat. No. 6,307,583 (ITW). In theory, this solution enables higher frequencies as each of the two reels is moved by a specific motor; however, this requires a complex arrangement, particularly with respect to motor control, in order to synchronise the movements and avoid any over-tension of the tape generating ruptures or interruptions. In particular, the document WO 02/22371 (Zipher) discloses different aspects to be controlled in this type of process. In addition, the mechanical clearances, particularly those generated while the motors are idle, may be difficult to compensate by simply controlling these two motors.

While, according to the invention, it is indeed desired to increase the printing speed and/or throughput, it seems inappropriate to accompany this improvement by an excessive complication of the system and an increase in costs due to the complexity and synchronisation between two drive motors. Therefore, the ribbon is driven by a unidirectional movement; however, this option generates significant jerking and may cause ribbon tensions such that it breaks during accelerations/decelerations due to the rapid movement of the ribbon. In addition, at high printing throughputs, wrinkles may be formed in the ribbon if its tension retention is not sufficiently uniform and precisely controlled. Finally, the measurement of the precise linear position of the ribbon may be rendered difficult due to this jerking, with adverse effects on the print quality or the ribbon consumption.

One solution to control the ribbon tension relates to the presence of a mechanical spring rocker arm on the path of the ribbon, in order to compensate for the inertia of the system during interruptions in the feed or different speed variations generated by the printing or non-printing phases: see document U.S. Pat. No. 5,647,679 (ITW). This solution may be accompanied by the presence of an associated brake, as presented in document U.S. Pat. No. 5,873,662 (ITW). However, the system retains high inertia and does not respond immediately to each tension variation; in addition, the latency before the response of the return springs is generally long and may fluctuate over time. Therefore, this solution has limitations at high unwinding speeds.

### DESCRIPTION OF THE INVENTION

The invention proposes, among other advantages, to remedy the abovementioned drawbacks of existing printing systems and, in particular, to increase the printing reliability, throughput and speed and to optimise the use of the ribbon without impairing print quality while controlling the costs.

In one of its embodiments, the invention relates to a thermal printer cassette comprising a support equipped with the various components necessary for the feed and unwinding of the ribbon. In particular, the support comprises rollers (also referred to as cylinders) delimiting the path followed by the ribbon and enabling the movement thereof. In particular, two rollers are intended to be coupled with the feed reel and the used ribbon reception reel; one of the two rollers is connected directly to a drive system, the other is rotated by the traction of the ribbon initiated by the motor-driven roller.

The driven roller, generally the feed roller, is preferably provided with a braking system which is used to modify the rotation speed of the associated reel according to the tension applied on the ribbon. In particular, the braking system may comprise a friction component coupled with the mechanism enabling the rotation of the roller, and which may be compressed using a component responding to the ribbon tension.

Preferably, the braking activation component moves according to the position of a ribbon tension compensation arm, for example, belonging to an associated rocker arm.

The cassette according to the invention also comprises a rocker arm, or compensator, on its driven roller, which consists of two cylinders attached to the support and a cylinder mobile relative thereto. Magnetic means, particularly magnets of the same pole, located on the cylinders of the compensator, repel them from each other, while the ribbon wound around them brings them closer together due to the applied force, which is in turn directly related to the tension thereof. Preferably, the compensator forms a triangle, the angle on the mobile cylinder being acute, less than 60°, for example of the order of 30°. According to a preferred embodiment, the mobile cylinder moves around the driven roller along an arc of a circle: a mechanical arm can connect the mobile compensator cylinder and the feed reel roller so as to communicate directly, via its relative angular position, the tension applied on the ribbon. In particular, a thread can connect this angle with respect to a braking system.

Preferably, the winding reel drive is indirect, i.e. the drive system comprises a first traction roller directly connected to the printer motor, and a second winding roller on which the retrieval reel is positioned; a belt is used to rotate the winding roller thanks the rotation of the traction roller.

Advantageously, the winding roller is provided with a locking system, for example an anti-rotation ring, so as not to undergo counter-rotation via a spring effect during jerking generated by the motor or by the elasticity of the belt. Similarly, the coupling interface between the traction roller and the rotation axis of the motor is preferably provided with a locking system, for example two opposite unidirectional bearings, to respond to the movements applied by the motor in an optimum fashion.

It is preferable to have a deflection roller between the traction roller and the drive rollers, in order to keep the arc of circle formed by the ribbon on the traction roller constant, and preferably between 190 and 240°.

The various improvements according to the invention may be made individually; the cassettes according to the invention may be used on new printing systems developed for that purpose or adapted on existing systems, for continuous printing or intermittent printing and alternative embodiments thereof.

### BRIEF DESCRIPTION OF THE DRAWINGS

Other characteristics and advantages of the invention will emerge more clearly on reading the following description and with reference to the appended figures, which are given as an illustration only and are in no way limitative.

FIGS. 1A and 1B show a device according to a preferred embodiment of the invention, with and without ribbon respectively.

FIGS. 2A and 2B illustrate preferred embodiments of the ribbon drive according to the invention.

FIG. 3 shows a compensator of a preferred embodiment according to the invention.

FIGS. 4A, 4B, 4C and 4D illustrate the driven feed roller braking system according to one embodiment of the invention, along with a schematic representation of its action.

### DETAILED DESCRIPTION OF SPECIFIC EMBODIMENTS

The cassette 1 according to the invention is intended to be fitted on a printing system comprising the heavy and non-consumable hardware of the printer, particularly the motors, printing head, wiring, etc. In standard operation, several interchangeable cassettes are generally used in succession on the same printing system. A cassette is reloaded with a new ribbon reel outside the machine, while the other cassette is in use. The replacement of the cassette in which the feed reel has been used up by a newly loaded cassette is performed in a few moments without penalising productivity.

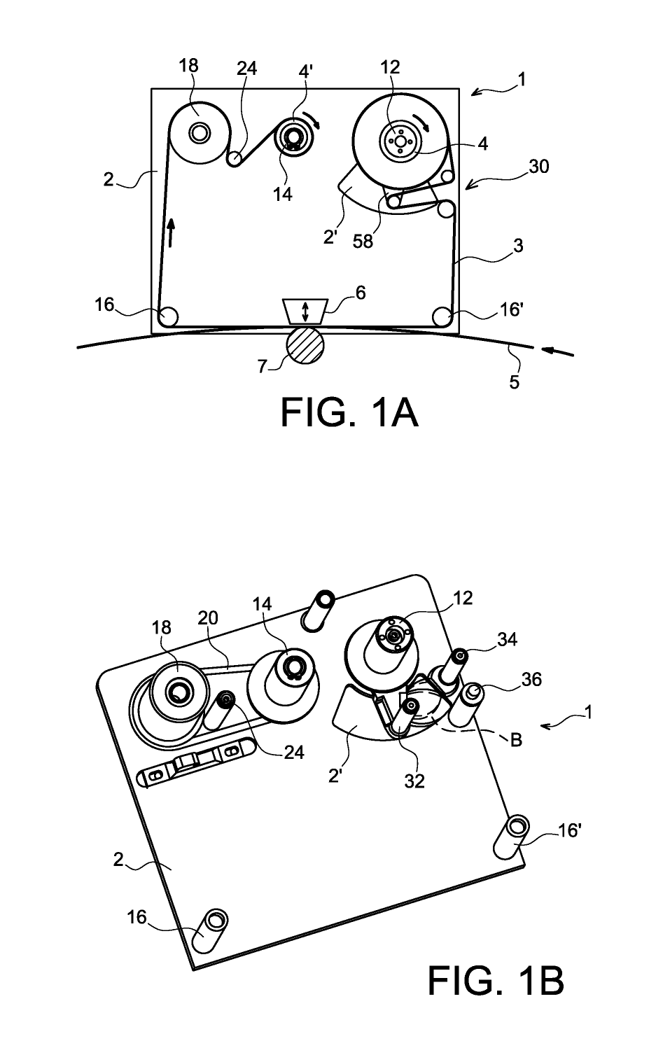

As is generally the case and represented in FIGS. 1A and 1B, a device 1 according to the invention comprises a support 2, for example a metal plate wherein the size and thickness depend on the printer in question, which makes it possible to support on one side the various components on and around which the printing ribbon 3 runs (the other side usually comprising a handle). Such a ribbon 3 is generally available in the form of a reel 4 wound around a hollow cylinder which may engage on one of the different rollers of the cassette 1; a reel 4 may comprise a typical length of 600 to 800 m of a ribbon 3 of a width typically of the order of 55 mm or 110 mm (depending on the width of the printing head of the system), provided on one of its sides at least with an ink adapted to the printing substrate 5 and to the heat developed by the printing head 6.

The substrate 5, for example a soft plastic wrapping film, particularly a heat-sealing film processed to form bags or seal food product containers, or a pharmaceutical blister pack, or a substrate comprising printable adhesive labels, or others, is driven by a relative translation movement with respect to the printing head 6. The printing head 6 is moved closer to the ribbon 3 for the patterns to be printed; the ribbon 3 is driven by a speed substantially equal to that of the substrate 5 during printing, and a back pressure cylinder 7 ensures the contact between the substrate 5 and ribbon 3 at the head 6 to optimise the thermal transfer. In intermittent printers, when the printing head is moved to cover the printing surface, this cylinder 7 is advantageously replaced by a back pressure plate corresponding to the surface covered. The printing head 6 may be fixed or mobile in the direction of movement of the substrate 5 and generally operates according to the different “continuous machine” or “intermittent machine” options: it will not be described in more detail.

Although it is not developed hereinafter, it is clear that the various rollers 10, also referred to as cylinders, are suitable for being fitted together, functionally or free in rotation, on corresponding components of the printing system. Their size, shape, composition and diameter depend on their use and will not be described in more detail, given that the parameters are similar to the existing ones (in particular, their height is greater than the width of the ribbon 3).

The device 1 comprises a first roller 12 on which a feed reel cylinder 4 is positioned, and a second roller 14 on which a second reel cylinder 4′, around which the used ribbon 3 will be wound, is positioned. The path between the first roller 12 and the second rollers 14 is delimited by at least two feed rollers 16, 16′ between which the printing head 6 may come into contact with the ribbon 3, also referred to as the feed path.

According to the invention, only one of the rollers supporting a reel 4, 4′ of ribbon is coupled with the motorisation, generally the used ribbon roller 14; the feed roller 12 is driven by the traction applied by the ribbon 3 during its movement.

The winding of the used ribbon is preferably carried out by means of an indirect drive system in order to harmonise the linear speed of the ribbon 3. The drive system comprises a first traction roller 18 directly actuated by the motor, for example inserted on the shaft of a step-by-step motor, and the second winding roller 14. The second winding roller 14 is driven by the motorised roller 18 via an actuation belt 20. Therefore, the ribbon 3 only covers an arc of a circle around the traction roller 18: in this way, the force applied by the traction roller 18 is constant and the linear speed of the ribbon 3 can be directly derived from the speed transmitted by the motor. This solution makes it possible to compensate for the difference in linear speed caused by the variation in diameter of the retrieval reel 4′ which is generated by the winding of the ribbon 3. The equilibration between both rotation speeds of both rollers 14, 18 is carried out by sliding the belt 20 around transmission pulleys positioned on the relevant rollers 14, 18.

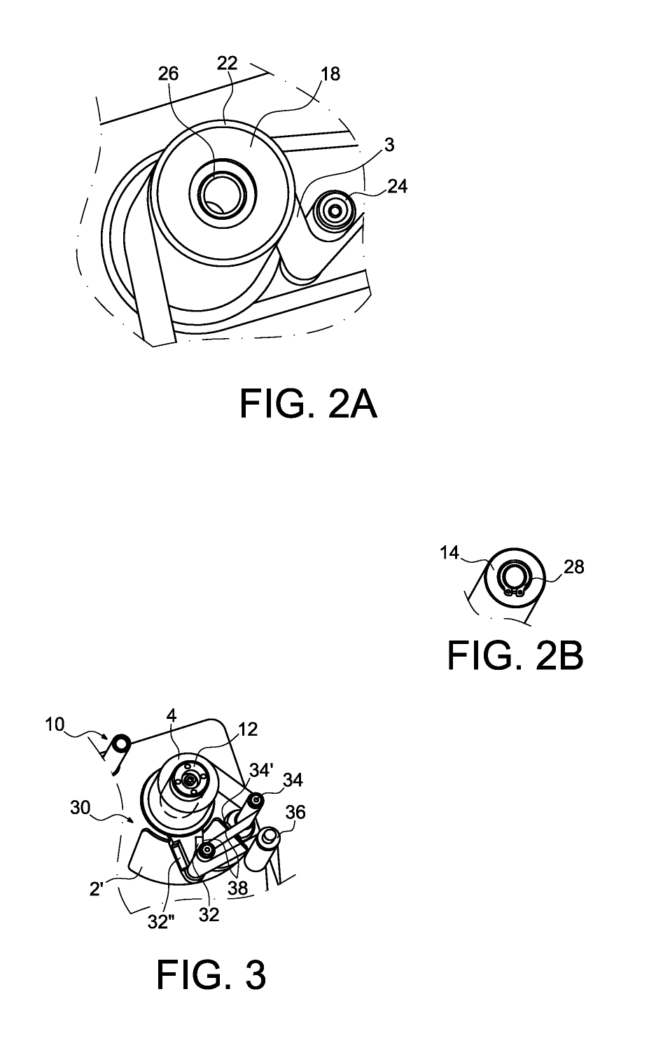

The traction cylinder 18 is covered with a suitable covering 22 (FIG. 2A), for example a sleeve of rubber-based material, enabling the ink ribbon 3 to temporarily adhere to it and not to slide during the rotation of the roller 18. Advantageously, the counting of the incremental rotation steps of the step-by-step motor or the use of a sensor at this level make it possible to determine the feed of the ribbon 3 and the remaining length on the feed reel 4.

According to the invention, a deflection roller 24 is positioned between the two rollers 14, 18 of the drive system, such that the ribbon 3 achieves, irrespective of the diameter of the used reel 4′, a constant angle around the traction roller 18, preferably greater than 180°, for example 190°, advantageously up to 240°. The deflection roller 24 makes it possible to ensure a constant and maximum contact surface area between the traction cylinder 18 and the ribbon 3, in order to increase the reliability and reduce further any risk of relative sliding, even at higher speeds or during acceleration phases. In this way, the precision of the determination of the length of ribbon that has been run can be fine-tuned, which makes it possible to optimise the quantity of ink used, to save on ribbon, and to increase the unwinding speed, without affecting the print quality, and even with improving it.

In addition, the traction roller 18 may comprise a locking system, such that any clearance is compensated between the motor shaft and the drive roller 18, so that there is no inertia during speed and direction variations transmitted by the motor. Advantageously, the locking system comprises two unidirectional anti-rotation bearings 26 mounted opposite each other: this makes it possible to compensate for any latency in the event of jerking induced by the drive motor.

The retrieval roller 14 may also comprise a locking system such that no reverse rotation is possible (FIG. 2B): an anti-rotation ring 28 only allowing the normal feed of the ribbon 3 prevents any recoil movement initiated by a spring effect during the possible slackening of the traction on the tape 3 or by the elasticity of the belt 20. In this way, the anti-rotation ring 28 prevents the reduction in tension of the ribbon 3 which would result in sliding of the ribbon on the traction roller 18, and therefore a loss of precision on the measurement of the actual feed of the ribbon 3.

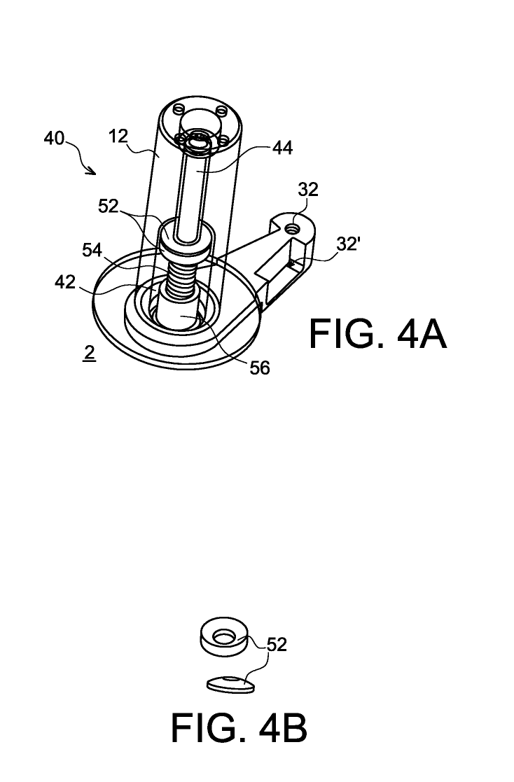

A rocker arm 30 is positioned on the driven roller 12, so as to compensate for the jerking of the ribbon 3 induced by the difference in drive speed between printing and non-printing periods and to compensate for the corresponding length of ribbon when the ribbon 3 is tensioned: according to the traction applied by the motor on the ribbon 3, the path followed by the ribbon around the rocker arm 30 varies. Such a rocker arm, or compensator, also known as a “dancing arm”, comprises a compensation cylinder or arm 32 which is mobile with respect to a fixed cylinder 34 and spring-like means prompting the mobile arm 32 in the opposite direction of the traction applied by a ribbon 3 wound around them. As illustrated in FIG. 3, preferably, the compensator 30 forms a triangular ribbon path, with the presence of two fixed cylinders 34, 36 forming a triangle, if possible substantially isosceles, of a variable angle with the mobile cylinder 32.

In particular, according to the invention, the rocker arm 30 is actuated magnetically and makes it possible to keep the tension of the ribbon 3 substantially constant for the ranges of jerks generated within the scope of the invention: in fact, the conventionally used springs have a latency limiting their reaction rate and therefore the compensated differences in speed and traction. According to the invention, the tension of the ribbon 3 may remain substantially constant even during rapid motor shutdown/start-up sequences; therefore, it is possible to increase the printing frequency and its rate, while reducing the risks of the ribbon 3 breaking.

The spring-like means keeping the rollers 32, 34, 36 at a distance against the action of the ribbon 3 comprise at least two magnetic components 38 of the same pole, and therefore subject to repulsion, attached to the mobile component 32 and at least one of the fixed components 34, 36, respectively. The magnetic components 38 are for example rare earth magnets, such as those based on neodymium, e.g. Nd₂Fe₁₄B; they may be in the form of cylindrical pellets arranged in support arrangements 32′, 34′ of the cylinders 32, 34 in question: the advantage of this choice is that the magnetic components can then emit a residual magnetic field of the order of 1.18 T for a pellet less than 8 mm in diameter. The magnets 38 are preferably identical for each of the cylinders 32, 34, but they may be different, particularly if three magnets are present; the arrangements 32′, 34′ are located such that, irrespective of the relative position of the cylinders, 32 on one hand and 34, 36 on the other hand, of the compensator 30, the field B generated by the magnets 38 is located at least partially in opposition (FIG. 1B).

The angle formed by the ribbon 3 on the mobile cylinder 32 is determined to minimise the reaction force acting on the ribbon 3 due to the inertia of the feed reel 4; it is acute, preferably closed, for example less than 60° and particularly of the order of 30°, such that the distance traveled by the ribbon 3 varies significantly according to the repulsion force B. A progressive effect in the feed of the ribbon 3 is obtained due to the action on the cylinder 32. This makes it possible to retrieve the length of the thermal ribbon liable to have been slackened during the printing process due to the winding inertia and the stress applied by the movement of the printing head 6.

If the traction force of the ribbon 3 increases by an acceleration of the motor, the inertia of the rocker arm supporting the mobile cylinder 32 being lower than the inertia of the feed reel supported by the cylinder 12, the mobile cylinder 32 will move closer to the fixed cylinders 34, 36 to release a length of ribbon more rapidly. If the traction force of the ribbon decreases during deceleration of the motor, the mobile cylinder 32 will move away from the fixed cylinders 34, 36 under the effect of the repulsion force B and will thus retrieve a ribbon length to maintain a suitable tension.

In addition, in the figure, the presence of a second arrangement 32″ liable to contain a magnet 38 is noted. Although it can be used to double the field B produced by the mobile cylinder 32, usually, it remains empty: in fact, this conception makes it possible to use the same cylinder support 32 indifferently for a compensator 30 operating in either unwinding direction, i.e. for a triangle arranged in a mirror view of that represented, i.e. for a so-called “right-hand” or “left-hand” cassette.

In addition, it is possible to transmit the level of tension of the ribbon 3 to a system 40 used to modify the unwinding speed of the feed reel 4. In this case in particular, advantageously, the movement of the mobile compensation cylinder 32 is radial with respect to the axis of the feed roller 12, and authorised by an arrangement 2′ in an arc of a circle around the driven roller 12 in the support 2.

To ensure a constant tension and optimise the consumption of the ribbon 3, a dynamic brake 40 is advantageously coupled with the feed roller 12, associated with the compensation arm 32: according to the position of the cylinder 32, directly linked with the tension applied by and on the ribbon 3, a braking device 40 has a more or less significant effect on the mechanism driving the rotation of the feed roller 12.

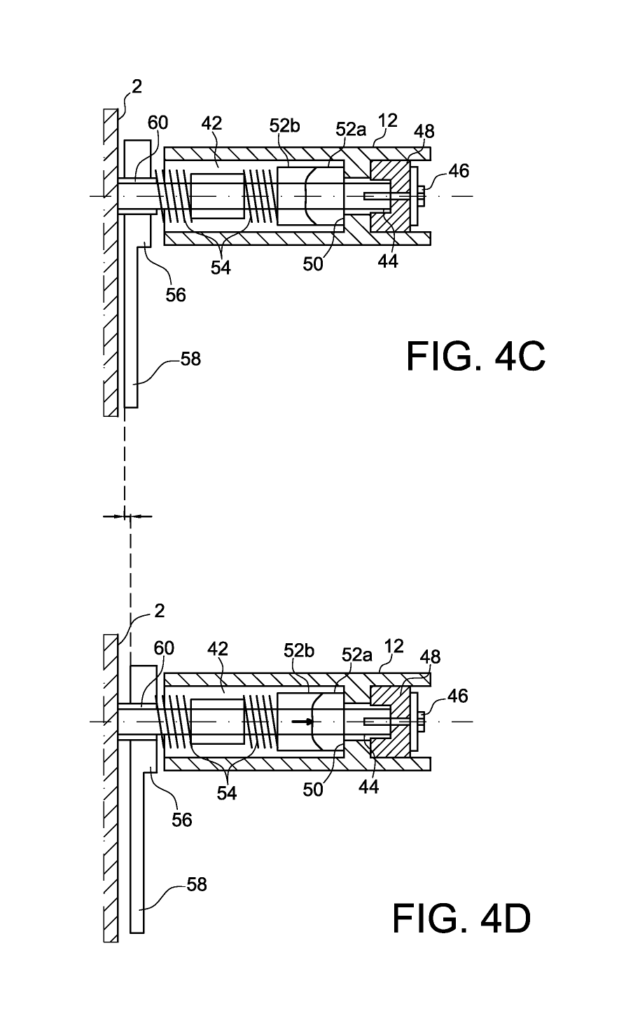

According to a preferred embodiment illustrated in FIG. 4, the dynamic brake mechanism 40 is arranged in a cavity 42 within the drive roller 12 extending along its axis of rotation 44 on a part near the support 2; the distance along the axis between the support 2 and the roller 12 is fixed, ensured by the length of the axis 44. More specifically, the roller 12 is fitted on the axis 44 and kept clamped by an attachment screw 46 attached to the end face of the axis 44. To enable free rotation of the roller 12, it comprises a countersink wherein a friction brace 48 is set and the attachment screw 46 comprises a washer that rubs against the brace 48.

To carry out the dynamic braking, the inside of the roller 12 further comprises a shoulder 50, against which an axial friction bearing 52 is placed; preferably, the bearing comprises a pair of two rings 52a, 52b of complementary shapes, for example hemispherical, mounted on the axis 44, such as the bearing Igubal® produced by Igus: the ring 52a is in continuous contact with the shoulder 50 of the feed roller 12, the hemispherical interface between the rings 52 forms the friction surface, the ring 52b closest to the support 2 is held by an axial force against the ring 52a by the action on its other side of an axially compressed spring 54.

When the spring 54 is more or less compressed, the friction force applied on the bearing between the rings 52a and 52b varies, thus applying a variable friction stress opposite the free rotation of the roller 12: the rings 52 acts as a brake gripper.

Preferably, the spring 54 applies a pressure on the bearing 52 even when not prompted, such that the arrangement of the rings 52 of complementary geometries makes it possible at the same time to absorb the variations of axial dimensions and the slight coaxial deviations of the roller 12 with respect to the axis 44 which are initiated during the assembly process and due to design tolerances.

At its end opposite the rings 52, i.e. close to the support 2, the spring 54 is in contact via an axial support, for example via a support component or directly via the axis 44, on a shoulder 56 in turn coupled with a mechanical extension, or arm, 58 of the compensation cylinder 32; in particular, the mechanical extension 58 forms a rotary radius centred on the axis 44 of rotation of the feed roller 12, such that the compensation cylinder 32 moves in an arc of a circle around it.

According to a preferred embodiment, the axis of the mobile assembly consisting of the cylinder 32, arm 58 and shoulder 56 comprises a thread, which enables it to be attached to a thread of the axis 44, such that the position of the component 56 with respect to the support 2 and along the axis 44 depends on the angular position between the axis 32 and the axis 44. Therefore, the mobile assembly can rotate freely around the axis 44, but this rotation induces a slight axial translation due to the connection via the threaded connection 60 which moves the free end of the spring 54 perpendicularly to the support 2, during the rotation of the arm 32, 58 with respect to the feed roller 12: the spring 54 is compressed, increasing the pressure on the bearing 52, and braking the rotation of the cylinder 12. It may be envisaged to replace the thread by an incline, or any other solution.

In this way, the control of the braking action depends on the tension of the ribbon 3 during the printing process and there is no mechanical or software control; the tension is known by the position of the mobile arm 32 of the compensator 30, which transmits the axial movements linked to the braking level required to guarantee the tension. In particular, when the tension is lower, the mobile arm 32 is in a deflected position (maximum path length of ribbon 3), maximum braking is obtained by maximum friction caused by the vertical movement; when the tension is higher, the mobile arm 32 comes to the minimum position and the angle of the triangle formed by the axes of the rollers 32, 34, 36 of the compensator is the most open, the braking is reduced by reduced compression of the spring caused by the vertical movement.

The device according to the invention makes it possible to improve thermal printing capacities:
The device 1 makes it possible to keep a printer at an economical cost as only one feed reel roller is motorised.
The device 1 makes it possible to minimise non-printed ribbon losses, by means of precise control of the position and feed of the ribbon 3, even at high speeds.
The tension of the reel is substantially constant, even when the motor shutdown/start-up sequences are close together: in this way, it is possible to intensify the printing rate and accelerate the frequency of use of the printing head 6, i.e. to print numerous items of information close together at high speeds, such as expiry dates for each of the capsules in a medicinal product blister pack, for example.
The printing speed may also be increased, e.g. doubled, with respect to existing systems particularly due to the control applied to the feed and tension of the ribbon 3, to reach 60 metres per minute for example.
Reels 4 of larger sizes, for example 1000 linear meters, may be used: the proposed solutions are effective even for greater reel diameters which generate higher inertia. As the reel changes are less frequent, the productivity losses due to machine shutdowns are lower.
There is no sliding between the ribbon 3 and the drive cylinder 18, which enables a precise measurement of the movement of the ribbon 3, and therefore savings thereof, while improving the printing quality.
The breaking frequency of the ribbon 3 is reduced due to the progressive effect caused by the dynamic brake 40 of the compensation arm 32.
The provided solutions may be applied to existing printing systems by means of a simple modification of the cassette (combined if applicable with a simple software adaptation to handle optimised motor control sequences), without calling the installed equipment into question.
The modifications are such that it is possible to produce with the same components 10 the “right hand” and “left hand” cassettes 1, i.e. any unwinding direction of the ribbon 3; to this end, for example, the support 32′, 32″ of the magnet 38 on the compensation arm 32 may be provided on either side.
The device 1 according to the invention can be adapted equally well to intermittent and continuous printing systems, and to alternative embodiments thereof.

Although they are described in combination, it is clear that the various components and modifications may be used separately.

The various improvements have proved, under typical industrial operating conditions, that the cassette 1 according to the invention made it possible for example to reach an effective printing speed of 54 m/min with a throughput of 900 prints/min using 60 m of ribbon without any risk of breaking the ribbon, while the data for a conventional cassette used in the same application were limited to 25 m/min with 200 prints/min using 100 m of ribbon.

1. Device for feeding a thermal printing ribbon comprising:
a support in the form of a plate,
a first feed roller protruding normal to the support and around which a ribbon feed reel may be positioned,
a second winding reel protruding normal to the support, which may be connected to rotation means, and around which a printed ribbon winding reel may be positioned,
a tension compensation mechanism of the ribbon, comprising at least two feed cylinders, one of them being fixed with respect to the support and the other being mobile, and return means pushing the mobile cylinder away from the fixed cylinder,
wherein the ribbon runs from the first feed roller to the second winding roller via the cylinders of the compensator/to form a feed path, which may be in contact with a printing substrate and whereon a thermal printing head may act,
characterised in that the return means comprise magnetic components repelling them from each other, one of which being attached to the mobile cylinder of the compensation mechanism, wherein the tension applied onto the ribbon brings the magnetic components closer together.

2. Device according to claim 1 wherein the compensation mechanism comprises a third feed cylinder fixed with respect to the support such that the ribbon forms a triangle between the two fixed cylinders passing via the mobile cylinder.

3. Device according to claim 2 wherein, in the idle position, the angle formed by the ribbon on the mobile cylinder is less than 60°.

4. Device according to any of claim 1 comprising guiding means of the mobile cylinder, such that it moves along an arc of a circle centred on the feed roller.

5. Device according to claim 1 wherein the magnetic components are neodymium-based magnets.

6. Device according to any of claim 1 wherein the feed rollers comprise a braking system.

7. Device according to claim 6 wherein the mobile cylinder of the compensation mechanism is connected in a fixed manner to a mechanical arm, which is functionally connected to the braking system.

8. Device according to claim 7 wherein the braking system comprises a spring-like component, the compression of which depending on the relative position of the mechanical arm with respect to the feed roller.

9. Device according to claim 8 wherein the mechanical arm comprises a threaded connection with the rotation axis of the feed roller and cooperating with the spring-like component.

10. Device according to claim 1 wherein the winding roller is coupled via a belt to a drive roller which can be coupled with the motor.

11. Device according to claim 10 comprising a deflection roller of the ribbon between the winding roller and the drive roller such that the arc of the ribbon around the drive roller is constant.

12. Device according to claim 11 wherein the arc formed by the ribbon is between 190 and 240°.

13. Device according to claim 10 wherein the drive roller comprises two unidirectional locking bearings.

14. Device according to claim 10 wherein the winding roller comprises a locking system.

15. Intermittent or continuous printing system comprising the device according to any of claims 1 to 14 and a thermal printing head.

16. Use of a mechanism 3 allowing the compensation of the tension of a moving ribbon in a thermal printing cassette, said mechanism comprising a mobile cylinder with respect to at least one fixed cylinder and repelled from each other by the action of a magnetic field.
